(19) United States
(12) Patent Application Publication
(10) Pub. No.: US 2014/0182281 A1
(43) Pub. Date: Jul. 3, 2014

(54) ROTATING WAVE ENERGY MACHINE

(71) Applicants: Nik Scharmann, Bietigheim-Bissingen (DE); Jasper Behrendt, Hamburg (DE); Benjamin Hagemann, Bad Segeberg (DE); Paul Zielke, Aschaffenburg (DE); Markus Perschall, Aschaffenburg (DE)

(72) Inventors: Nik Scharmann, Bietigheim-Bissingen (DE); Jasper Behrendt, Hamburg (DE); Benjamin Hagemann, Bad Segeberg (DE); Paul Zielke, Aschaffenburg (DE); Markus Perschall, Aschaffenburg (DE)

(73) Assignee: Robert Bosch GmbH, Stuttgart (DE)

(21) Appl. No.: 14/125,872

(22) PCT Filed: Jun. 15, 2012
(86) PCT No.: PCT/EP2012/002550

§ 371 Date: Mar. 7, 2014

(30) Foreign Application Priority Data
Jun. 16, 2011 (DE) 10 2011 106 596.6

(51) Int. Cl. F03B 13/18

(52) U.S. Cl. CPC F03B 13/18
USPC 60/499

(57) ABSTRACT

A rotating wave energy machine includes at least one rotor that revolves in a synchronous manner for utilizing an orbital flow of an undulating body of water that circulates over the rotor. An output power is tapped at a rotor shaft and the power (in the power flow) is converted by at least one lift device of the rotor. A cross-section of the lift device includes at least one curve or angle that is shaped depending on a curve of a total flow. The at least one angle or curve is configured such that the influence of the relative flow on the total flow is taken into account. When the rotating wave energy machine is operational, the relative flow is superposed on the circulating orbital flow that acts on the lift device from outside, and a total flow is produced which is curved about the rotor shaft.

The invention relates to a rotating wave energy machine according to the preamble of patent claim 1.

The invention relates to a wave energy machine for converting wave energy of bodies of water—in particular seas—into usable energy. A multiplicity of such wave energy machines are known from the prior art. They can be differentiated according to their location of use, depending on whether they are arranged in the open sea or near to a coast. Another differentiation relates to how the energy is extracted from the wave motion. For example, buoys or floats which float on the surface of the water are known, wherein, for example, a linear generator is driven by the up and down movement of said buoys or floats. In another machine concept, referred to as the “wave roller”, a planar resistance element is attached to the sea floor and is tilted to and fro owing to the movement of the water. The kinetic energy of the resistance element is converted, for example, into electrical energy in a generator. An overview of wave energy power plants is presented in the book “Renewable Energy” by Godfrey Boyle.

Furthermore, wave energy machines of the generic type are known whose crankshaft or rotor shaft is arranged essentially under the surface of the water and is made to rotate by a circulating orbital flow of water particles.

On the basis of this principle, a machine concept is known from the publication: “A rotating wing for the generation of energy from waves” which was published by Pinkster et al. in 2007, in which machine concept the buoyancy of a wing profile against which there is a flow is converted into rotation.

A disadvantage of such rotating wave energy machines is that the configuration does not take into account an influence of a flow component which arises from the rotation of the rotor. In this context, this flow component depends essentially on the length of a lever arm and the rotational speed of the rotor. Since the rotation of the rotor is preferably to take place largely in synchronism with the orbital flow, the rotational speed of the rotor results from the period length of the currently present wave with its orbital flow. This flow component is referred to below as the relative flow and during operation of the rotating wave energy machine it is superimposed on the circulating orbital flow which acts on the rotor from the outside. This gives rise to a resulting total flow which is curved about the rotor shaft, at every instantaneous recording. Therefore, conventional shaping of a buoyancy device, for example of a wing, which, according to the prior art, is adapted to a linear incoming flow, does not have an optimum efficiency level during rotation about the rotor shaft.

The invention is accordingly based on the object of providing a rotating wave energy machine with a buoyancy device for using a circulating orbital flow of an undulating body of water which has an improved efficiency level.

This object is achieved by means of a rotating wave energy machine having the features of patent claim 1.

The rotating wave energy machine according to the invention serves for using a circulating orbital flow of an undulating body of water via at least one rotor, which rotates largely synchronously, at the rotor shaft of which it is possible to tap an output power which is converted by means of at least one buoyancy device of the rotor. A cross section of the buoyancy device has at least one curvature or a bend which is embodied as a function of a curvature of a total flow. In this context it is possible to provide, in particular, that this curvature or bend is adapted to an average operating state. This means a change in the at least one curvature or bend with respect to a cross section, optimized for a linear incoming flow, according to the prior art. The configuration of the at least one curvature or the bend also takes into account the influence of the relative flow on the total flow, which is produced as a result of the (desired) rotation of the rotor. This relative flow is superimposed, during operation of the rotating wave energy machine, on the circulating orbital flow which acts on the buoyancy device from the outside. This gives rise to a resulting total flow which is curved about the rotor shaft, at each instantaneous recording. As a result of this at least one curvature or bend, the efficiency level of the buoyancy device is improved compared to a conventional cross section which is optimized for a linear incoming flow.

The rotor shaft is preferably arranged transversely with respect to a current direction of wave propagation and largely horizontally under the surface of an undulating body of water, preferably an ocean.

Further advantageous refinements of the invention are described in the dependent patent claims.

The total flow is not uniform in real use of the wave energy machine, when considered over time. These differences arise owing to the nonuniform state of the sea and/or the varying wave energy over time. Therefore, once a curvature or bend has been selected for the buoyancy device, for example a wing, said curvature or bend has a different efficiency level, which is not optimum, at various times. Accordingly, it is particularly preferred if the curvature and/or the bend can be set actively or changed passively. For this purpose, a sensor system for detecting the orbital flow and/or the local flow conditions at the buoyancy device and/or an operating state of the wave energy machine, in particular angle and/or position of the rotor and/or settings of the buoyancy device is preferred, as is a closed-loop control system.

Since the flow field of the total flow is a largely circular vector field, during the adaptation of the buoyancy device the procedure is particularly preferably carried out according to conformal transformation according to the rule w=e^{z}, which corresponds to transforming a Cartesian coordinate system into a polar coordinate system, wherein z represents the complex original image plane and w represents the complex image plane. Possibly present distortion of the vector field of the total flow compared to a circular embodiment in the case of machines with a large radial extent due to transverse effects and depth effects can be taken into account by corresponding adaptation of the conversion rule.

Alternatively, the bend can be set actively or changed passively by means of at least one flap which is coupled to a main section of the buoyancy device. In this context it is preferred if the latter is coupled in the central and/or rear third of the cross section.

The wing can be embodied here as a multi-element airfoil. For this purpose, in each case a distance or a gap is provided between the main section and the flap and between the flap and a further element. Such multi-element airfoils have relatively high buoyancy coefficients and are more robust with respect to flow detachment.

In terms of device technology it is simple if the buoyancy device is a bent planar element which has the curvature.

In one development, the buoyancy device has a multiplicity of individual buoyancy elements, preferably wings, which can be rotated or pivoted separately from one another about their respective longitudinal axis (that is to say transversely with respect to the direction of wave propagation).

In one preferred development with a plurality of buoyancy elements, a depth (or a dimension in the rotating direction) of the individual buoyancy elements or a distance between the individual buoyancy elements is selected in such a way that they form, in a basic position, an arc in cross section and can touch one another at the same time. Furthermore, the buoyancy elements can be rotated or pivoted into an opened position, as a result of which the bends are reduced with respect to the basic position, that is to say the approximated curvature is reduced. As a result, it is possible to adapt the bends according to the invention to reduced radii of the orbital flow or of the total flow.

In another preferred development with a plurality of buoyancy elements, the depth (or the dimension in the rotating direction) of the individual buoyancy elements or a distance between the individual buoyancy elements is likewise selected in such a way that they form, in a basic position, an arc in cross section and can touch one another at the same time. Furthermore, the buoyancy elements can be rotated or pivoted into an opened position, as a result of which the bends are enlarged with respect to the basic position, that is to say the approximated curvature is made more pronounced. As a result, it is possible to adapt the bends according to the invention to enlarged radii of the orbital flow or of the total flow.

One side of the buoyancy device faces an eye/zero point of the total flow, wherein the other side of the buoyancy device faces away from the eye/zero point of the total flow. In this context, the eye of the total flow is formed at a location at which the orbital flow and the relative flow compensate one another.

Further adaptation possibilities and optimization possibilities of the buoyancy are obtained if an angle of attack of the buoyancy device can also be set actively or changed passively.

In particular in the case of wave energy machines with a large transverse extent with respect to the direction of wave propagation, further adaptation possibilities and optimization possibilities of the buoyancy are obtained if different angles of attack can be set actively or changed passively along the buoyancy device or in the longitudinal direction of the buoyancy device (that is to say transversely with respect to the direction of wave propagation). As a result, the wave energy machine can also be rotated about its vertical axis and therefore oriented in an optimum way transversely with respect to the direction of wave propagation.

For this purpose, the buoyancy device can have a multiplicity of segments, the different angles of attack of which can be set actively or changed passively along the buoyancy device or in the longitudinal direction of the buoyancy element.

Alternatively, the different angles of attack can be set actively or changed passively by means of a plurality of flap segments which are coupled to a main section of the buoyancy device.

The flow can be improved if the at least one buoyancy device has an elastic outer skin. This brings about a certain degree of smoothing of the outer sides of the buoyancy element around which there is a flow.

This elastic outer skin is preferred in particular in the development with the multiplicity of segments. In this context, in order to improve the fine-stepped adaptation, a plurality of comparatively narrow segments can be provided along the longitudinal direction (that is to say transversely with respect to the direction of wave propagation).

Alternatively, the different angles of attack can be set actively or changed passively by means of a flap which can be twisted along its length and is coupled to a main section of the buoyancy device.

Each buoyancy device is preferably attached to the rotor shaft by means of at least one respective lever arm. Two lever arms are preferably provided on end sections, spaced apart from one another transversely with respect to the direction of wave propagation, of the rotor shaft and of the buoyancy device. However, arrangements with just one lever arm are also possible, said lever arm engaging, for example, centrally on the buoyancy device or, in particular, preferably on one side thereof, with the result that free ends are produced on the buoyancy device. These free ends can be provided with winglets in order to increase the efficiency. In this case, the term lever arms is also understood to include planar elements ranging as far as circular disks.

The distance between the eye/zero point of the total flow and the rotor shaft varies over time. These differences arise owing to the state of the sea which is not uniform over time or the varying wave energy. As a result, the curvature of the total flow at the position of the buoyancy device also changes, which curvature is then, under certain circumstances, no longer configured in an optimum way for the total flow which is then present. By changing the length of the lever arm it is possible to move the buoyancy device to another position in the field of the total flow with a different curvature. Correspondingly, it is particularly preferred if at least the length of the at least one lever arm can be set.

In addition to a rotation of the buoyancy device about its suspension point from the lever arm, said device can be adjustable in order to set the angle of attack with respect to an outer end section of the lever arm along a curved or elliptical path, or in a special case along a circular path. This results in minimum resistance during the adjustment of the angle of attack.

Alternatively, in order to set the angle of attack of the buoyancy device at least one trimming rudder is coupled thereto. As a result, a fixing of the buoyancy element, for example to the end of the lever arm, can be eliminated, and subsequently a new angle of attack is set with adjustment of the trimming rudder, and finally the fixing is activated again.

The trimming rudder can be coupled to a flap or to a main section of the buoyancy element or to a rear edge or to a front edge (viewed in the circulating direction) of a wing or of a bent planar element.

In one preferred development of the wave energy machine according to the invention, an output power for controlling a phase angle between the orbital flow and the rotor is provided. This controls a braking torque in order to generate (within certain limits) synchronicity between the orbital flow and the rotor. This braking torque can be produced, for example, with a generator, a pump and/or a brake.

Through such synchronicity, the angle between the connecting line between the rotor shaft and the eye/zero point of the total flow relative to the connecting line between the rotor shaft and the buoyancy device can be kept largely constant.

Various exemplary embodiments of the invention are described in detail below with reference to the figures, of which:

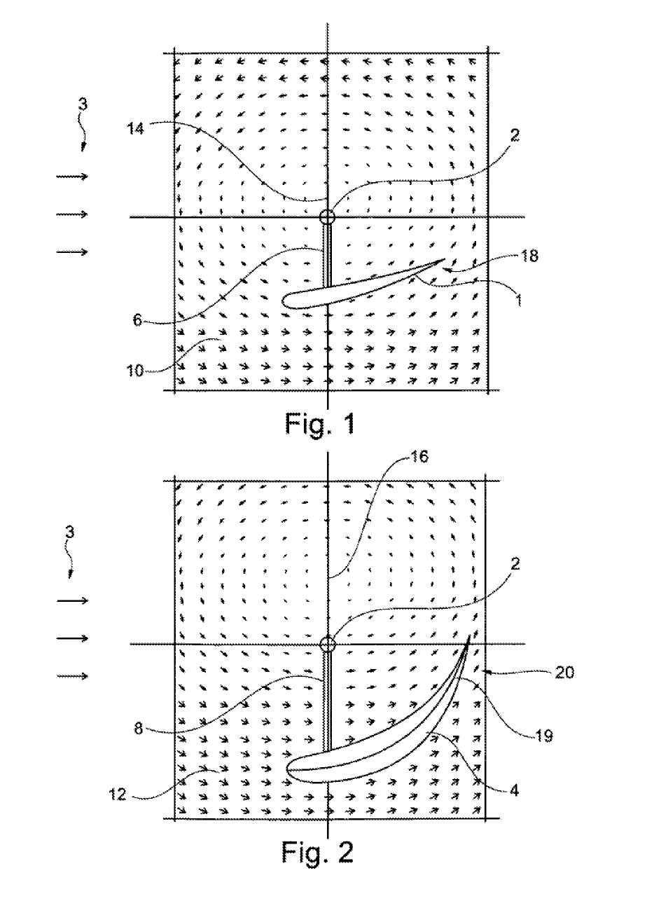

FIG. 1 shows a wing of a wave energy machine according to the prior art in a lateral section;

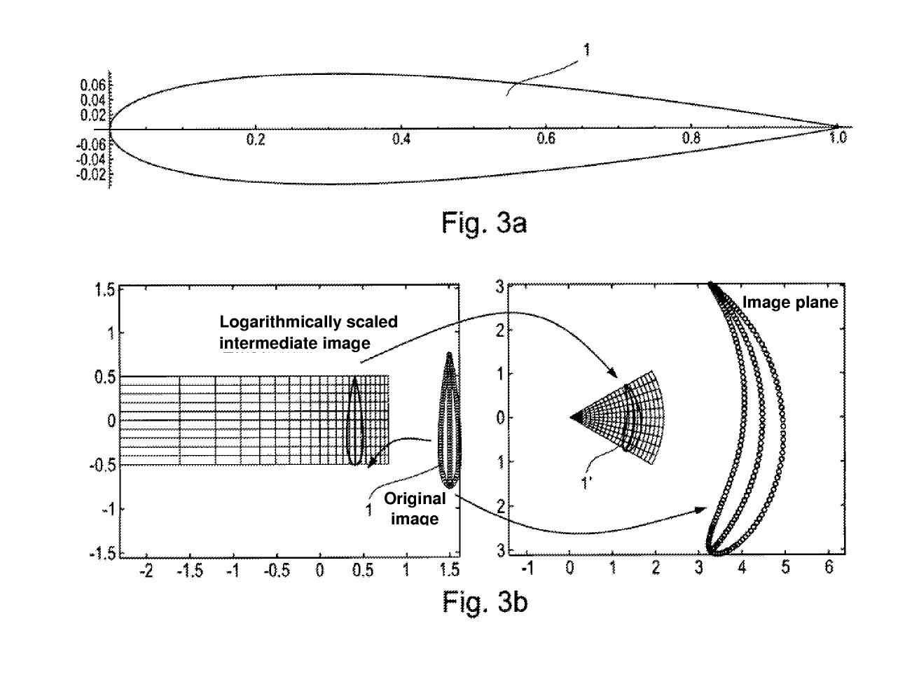

FIG. 2 shows a wing of a first exemplary embodiment of the wave energy machine according to the invention, in a lateral sectional illustration;

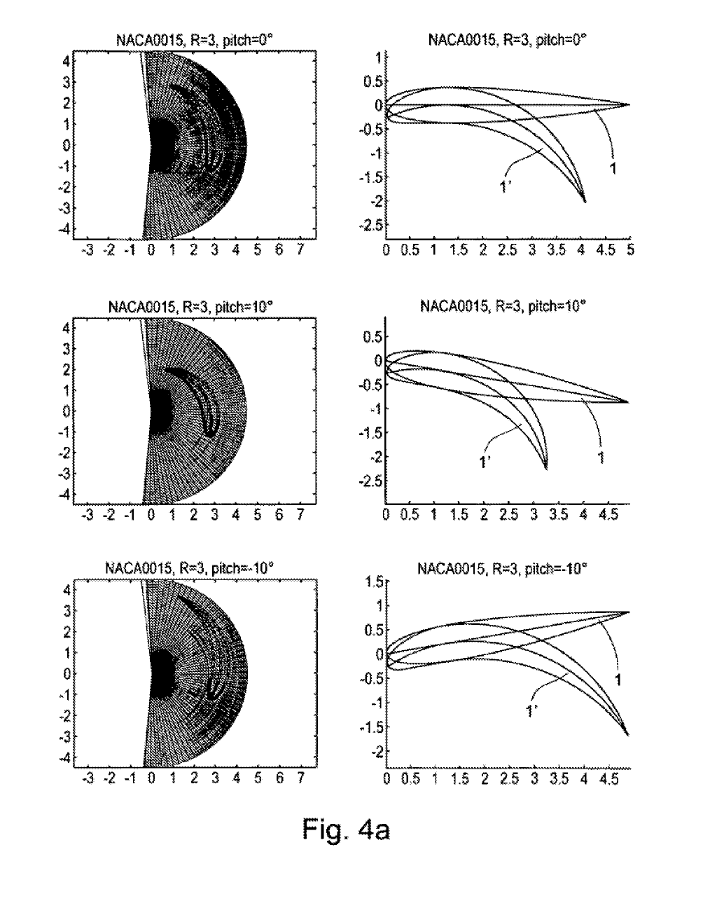

FIGS. 3a and 3b show preliminary considerations of the inventive curvature of a wing profile (known from the prior art);

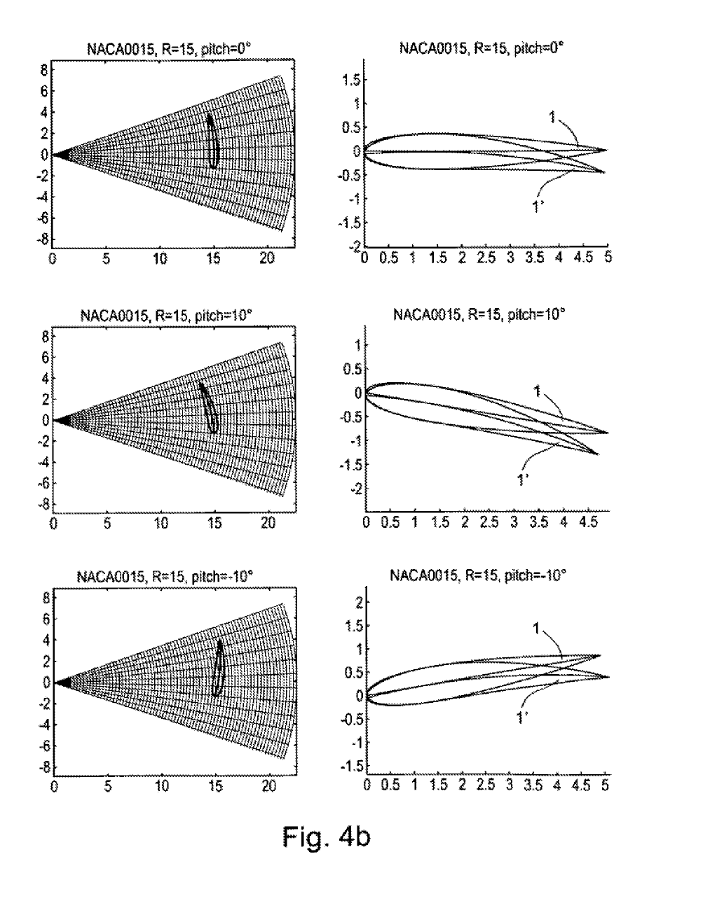

FIGS. 4a to 4e show examples of inventive curvatures of various wing profiles (known from the prior art);

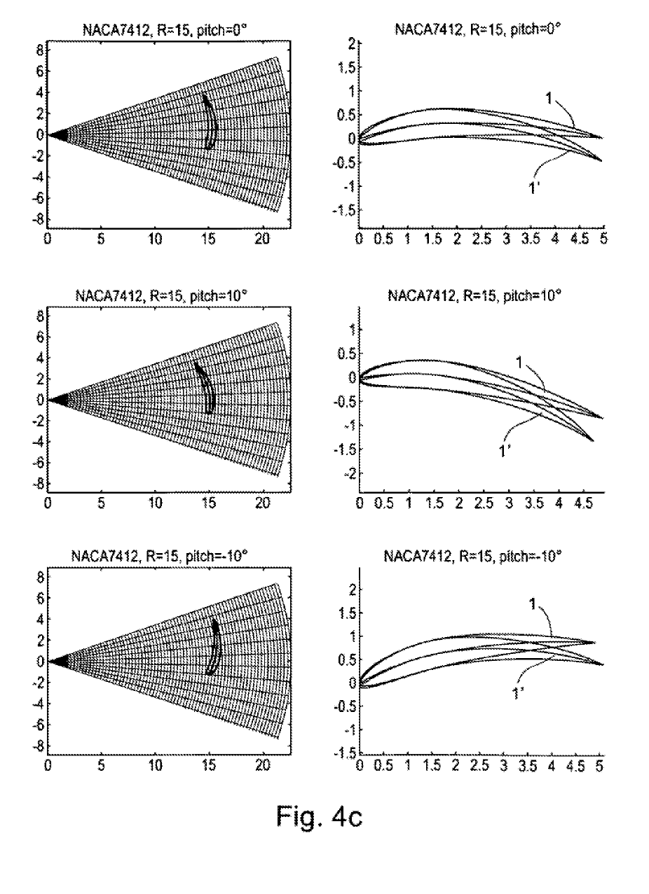

FIG. 5 shows a multi-part buoyancy device of a second exemplary embodiment of the wave energy machine according to the invention, in a lateral illustration;

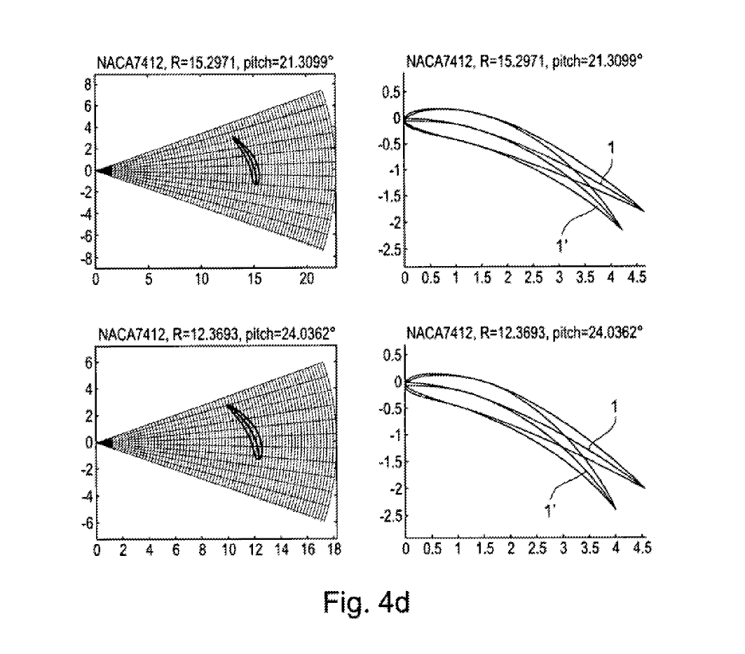

FIG. 6 shows a multi-part buoyancy device of a third exemplary embodiment of the wave energy machine according to the invention, in a lateral illustration;

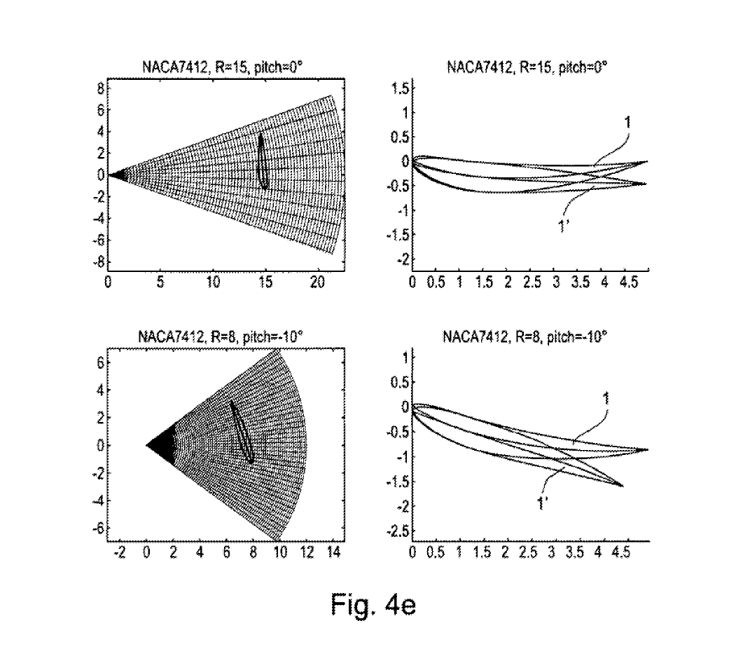

FIG. 7 shows a rotor of a fourth exemplary embodiment of the wave energy machine according to the invention with adjustment of the angle of attack in a lateral illustration;

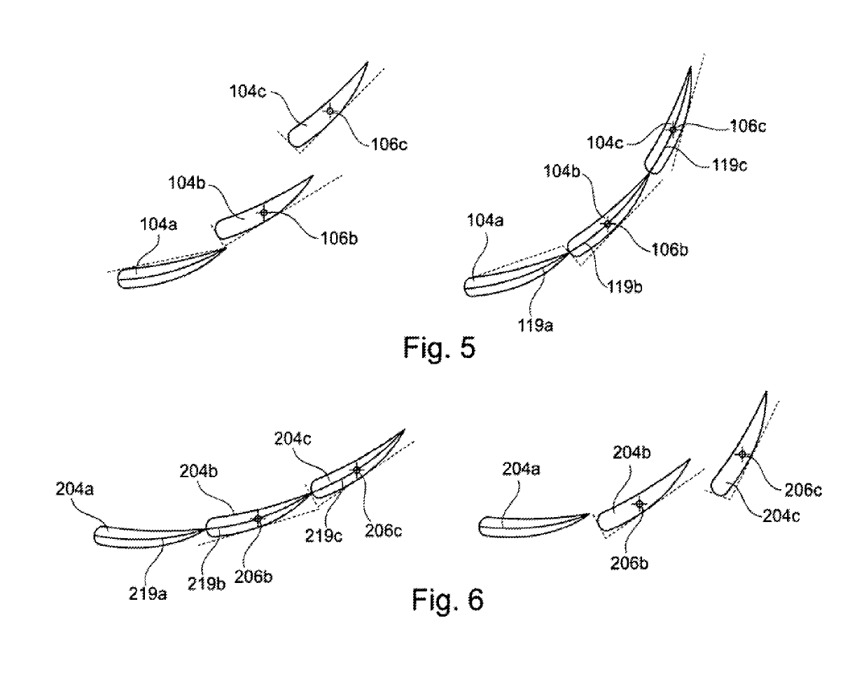

FIG. 8 shows a wing-like buoyancy device of a fifth exemplary embodiment of the wave energy machine according to the invention in a perspective view; and

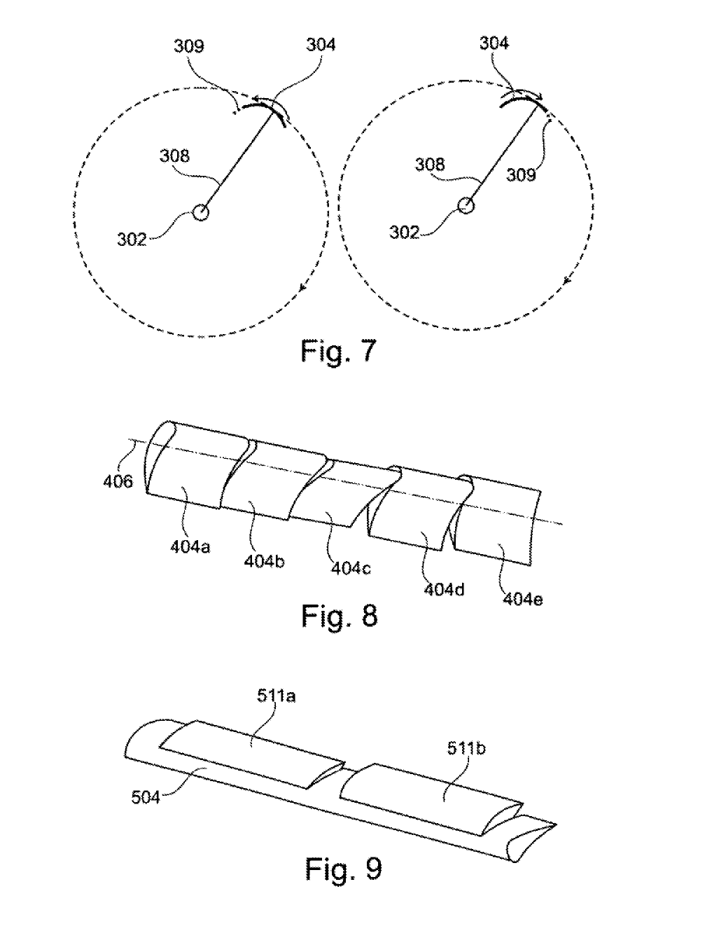

FIG. 9 shows a wing of a sixth exemplary embodiment of the wave energy machine according to the invention, in a perspective view.

FIG. 1 shows a wing 1 and a rotor shaft 2 of a wave energy machine according to the prior art, and FIG. 2 shows a wing, which is curved according to the invention, and the rotor shaft 2. Both wave energy machines (according to the prior art and according to the invention) utilize an orbital flow 3, caused by a wave motion, of a sea. At a point under consideration, the surface of the sea above the wave energy machine is firstly located at a maximum (peak of a wave) before it drops, makes a zero crossover and then subsequently reaches a minimum (wave trough). Subsequently, the surface of the sea at the point under consideration rises again, in turn makes a zero crossover and reaches a maximum again. After this, the cycle begins anew.

Water particles which are located under the wave peak firstly move in the direction of propagation of the wave (from left to right according to the three arrows in FIGS. 1 and 2) at the point under consideration. At the subsequent zero crossover, these water particles move downward, under the wave trough, counter to the direction of propagation of the wave, and upward at the subsequent zero crossover. It becomes apparent that the water particles move in orbital paths which circulate in the clockwise direction (given a direction of wave propagation from left to right).

FIGS. 1 and 2 illustrate an instantaneous direction of the orbital flow 3. This instantaneous recording corresponds to the situation under a wave peak given a direction of wave propagation from left to right. In this context it is assumed in a simplifying fashion that there is a uniform flow from left to right through the entire illustrated region at the illustrated time. This simplification disregards depth effects with a decreasing flow speed and transverse effects. For rotor diameters which are small compared to the wavelength this is possible, and in the case of large rotor diameters these effects would otherwise have to be included.

The wings 1 and 4 (according to the prior art or according to the invention) extend into the plane of the drawing and run largely parallel to the rotor shaft 2 here. At at least one point, preferably one of the two end sections of the rotor shaft 2 and of the wing 1 or 4, in each case one lever arm is arranged, of which in each case just one lever arm 6 or 8 is shown in FIGS. 1 and 2. At least part of the buoyancy force of the wing 1 or 4 is output as a torque to the rotor shaft 2 by means of the lever arms 6 and 8, respectively.

According to the prior art, the wing 1 has a curvature or bulge in its cross section which is optimized with respect to a linear incoming flow, such as occurs, for example, in the case of aircraft. This curvature or bulge is suitable for a pure orbital flow 3, since in the instantaneous recordings shown in FIGS. 1 and 2 said curvature or bulge runs approximately linearly (from left to right).

The rotation of the rotor about the rotor axis results in an additional relative flow. For each point, said relative flow is oriented perpendicularly with respect to the connecting line between the center of rotation and the respective point. Furthermore, said relative flow is proportional to the distance from the center of rotation. This results in a circular vector field with a zero point at the center of rotation for a pure rotation of the rotor without a superimposed orbital flow 3.

The superimposition of the orbital flow 3 (on the basis of the wave) and of the relative flow (on the basis of the rotation of the rotor) results in a total flow 10 and 12, respectively, which acts on the rotor and which is illustrated in each of FIGS. 1 and 2 as a vector field for the time of an incoming flow from the left.

In this context, the total flow 12 in FIG. 2 is represented for relatively large wave heights and therefore, by association, for relatively high flow speeds of the orbital flow, while in FIG. 1 relatively low flow speeds are assumed.

In both figures, a center 14 or 16 can be seen at which the resulting total flow 10 or 12 is zero. The position of these centers 14, 16 is dependent on the two superimposed speeds. Owing to the required synchronicity (T_{w}˜T_{R}) there is in principle a radial distance between this center 14 or 16 and approximately the radius of the orbital movement 3 in the immersion depth of the rotor shaft 2.

Likewise, owing to the required synchronicity, the centers 14, 16 orbit about the center point with the same rotational speed as the buoyancy device 1, 4, with the result that the angle between the centers 14, 16 and the buoyancy device 1, 4 remains essentially constant. However, owing to changes in the wave states the radial distance of the centers 14, 16 from the rotor shaft 2 changes here.

It is apparent in FIG. 1 that standard wing profiles, in particular with a large depth, do not have an optimum flow against them in the field of the total flow 10. If, for example, a front projecting base point of the wing 1 is always positioned with respect to the total flow 10, by means of an open-loop/closed-loop controlled braking torque and/or by setting the angle between the wing and the lever arm, such that its projecting base point has an optimum flow against it, a total flow 10 which, in contrast to cases of linear flow fields, is directed through the rear region 18 of the wing 1 is produced at the rear end or in the rear region 18 of the wing 1. In this context, preferred angles of attack are in the range from 0° to 15° in terms of absolute angle.

In contrast, the wing 4, shown in FIG. 2 and adapted according to the invention to the curvature of the total flow 12, is configured in such a way that it always experiences an optimum incoming flow, corresponding in principle to the conditions in the case of a linear flow against a wing which is not correspondingly adapted.

In the illustrated flow vector field, the wing 4 according to the invention therefore has improved buoyancy, at least one component of which is applied to the rotor shaft 2 as a torque via the lever arm 8.

The positioning of the wing 4 in FIG. 2 under the rotor shaft 2 (6 o'clock position) is by way of example. In order to generate an optimum torque it is therefore also possible to arrange the wing 4 in FIG. 2 further to the right, that is to say on the lee side of the rotor shaft 2 (in a 3 o'clock position) with respect to the orbital flow 3.

In this context, the curvature of the wing 4 which is adapted to the total flow 12 is preferably adapted to the flow field according to conformal transformations 1′. This procedure is described in more detail with reference to FIGS. 3 and 4 which follow. The conformal transformations are always characterized by the reference number 1′ in these figures.

In this context, NACA profiles are used for the purposes of illustration. Alternatively, it is, however, also possible to use other types of profile. Profiles with a less high increase in speed than is found in the case of NACA profiles (for example Eppler profiles) are preferred.

FIG. 4a shows in this respect an example of a symmetrical wing profile according to the NACA standard (NACA0015) and the influencing thereof on the basis of the relative flow by means of the intrinsic rotation. FIG. 4a still does not take into account any superimposed orbital flow, and the vector field of the relative flow is directed in a circular form around the origin. In this context, the geometry of the curved wing profile is illustrated on the left in the resulting vector field of the relative flow, while on the right-hand side the uncurved and the curved profile are shown superimposed for comparison.

A wing with a chord length of 5 m, which rotates about the origin on a lever arm of R=3 m length, is illustrated. The wing is secured at ¼ of the chord length and can be rotated (pitched) about this securing point. Owing to the lever arm which is short compared to the wing depth, relatively strong curvature of the wing profile occurs when the vector field of relative flow is taken into account.

In order to convert the uncurved NACA profile according to FIG. 3a into the curved vector field, the following method according to conformal transformations is used as the basis here. This is explained with reference to FIG. 3b. In a first step, the standard NACA profile whose coordinates are defined on a standard basis by z=x+iy according to FIG. 3a in the complex numerical plane, and which is based on a horizontal orientation of the wing with an arrangement of the projecting base point at the origin, is transformed by coordinate transformation into a wing which is directed vertically downward, and the securing point of which is located on the x axis: z₂=(y+R)+i*(x−shift); with the lever arm length R (in FIG. 4a R=3 m) and shift−the distance of the securing point of the wing from the projecting base point (in FIG. 4a shift=5 m/4). In the next step, according to FIG. 3b on the left, an intermediate figure z′ is generated in which the wing profile is logarithmically compressed in the x direction (wing thickness) and with the rule 1/R in the y direction (wing depth): z′=In=(y+R)+i*((x−shift)/R). This scaling is necessary since otherwise a severe increase would occur in the geometry owing to the conformal transformation (see right-hand wing in the plane of the image of FIG. 3b). In conclusion, the intermediate image z′ is transformed on the right into the polar plane by the computing rule w=e^{z′} according to FIG. 3b.

In the two lower illustrations in FIG. 4a, the cases are illustrated in which the profile is operated at an angle of attack □. The latter is, for example +10° and −10°. These angles of attack □ were included in the calculations before the above-described transformation by means of the transformation x=x_{F}*cos(□)−y_{F}*sin(□) and y=x_{F}*sin(□)+y_{F}*cos(□), with the profile coordinates x_{F} and y_{F}. Compared to the case which is not assumed, there is a significantly changed wing curvature and position of the wing in the vector field. Furthermore, the chord length of the wings also changes as a result of the transformation rule.

FIG. 4b illustrates the same three configurations for an NACA0015, wherein the lever arm length has been enlarged to 15 m. The significantly smaller resulting curvature of the wing for all three illustrated cases can be seen clearly. Only the influence of the relative flow has been taken into consideration here also. Details are not yet given on an orbital flow.

FIG. 4c illustrates the same three configurations, wherein, instead of a symmetrical (and therefore initially curved) NACA0015 profile, a curved profile (for example NACA7412), also with a chord length of 5 m and a lever arm R of 15 m, has been used. Changes are also apparent in the curvature of the profile here as a result of the described transformation.

The influence of the orbital flow will now also be examined in FIG. 4d. In this context, it is assumed for the upper diagram that the center is in the original image plane 3 m above the x axis on the y axis, and the lever arm extends to the right with a lever arm length of R=15 m along the x axis. As a result of the conformal transformation with the origin of the polar coordinate system at the center (flow speed equal to zero) the illustrated geometry of the wing is obtained.

The same occurs in the second transformation in FIG. 4d, wherein here the center is located at (3 m/3 m) relative to the origin of the noncurved coordinate system with the center of rotation at the origin.

FIG. 4e shows various cases in which the orientation of the curved wing (NACA7412) is selected such that the pressure side points outward. In this context, in the lower case where R=8 m a relatively short lever arm in combination with an angle of attack of −10° was selected in order to illustrate the distortion effect even more clearly. No orbital flow is taken into account in these transformations either.

The illustrated curved profiles are obtained with the discussed transformation rule. They exhibit a significant change compared to the curved initial profile (for example NACA7412 again). Here too, the chord length changes, but in particular the originally present curvature changes very strongly so that in the second case the chord is already embodied slightly in the shape of an s. As a result, it becomes apparent how important solely taking into account the relative flow is for the configuration of the wing geometry. Superimposing the orbital flow leads, as illustrated in FIG. 4d, to further changes in the wing geometry.

As the lever arm length increases, there is a decrease in the wing curvature, given the same wing depth, as a result of the conformal transformation, until the original profile is obtained again for R=8. As R increases, there is also an ever smaller deviation in the curvature of the profiles for various angles of attack and positions of the eye given the same wing depth. This effect can already be clearly observed if, as illustrated, the lever arm length is increased from 3 m to 15 m. Lever arm lengths of such wave energy converters can lie in the range from 1 m-50 m, preferably 3 m-40 m, particularly preferably 5 m-30 m and quite particularly preferably 7 m-20 m. This results in the particularly preferred solution of configuration of the wing geometry for an average operating case without including adjustment for the curvature or bend. As a result, in operating cases which differ from the ideal, slightly deviating wing geometries with reduced efficiency result; this can, however, be over-compensated by the reduced complexity of the machine with a relatively higher level of robustness and therefore lower operating costs and maintenance costs under certain circumstances. This cost factor has considerable influence particularly in the offshore area.

FIG. 5 shows a three-part buoyancy device according to a second exemplary embodiment of the wave energy machine according to the invention in a lateral illustration. The buoyancy device has a settable bend and, for this purpose, has three wings 104a, 104b, 104c which are arranged parallel to one another and are in principle of comparable shape and extend parallel to one another and perpendicularly with respect to the plane of the drawing. The three wings 104a-c each have at least one lever arm (not shown in FIG. 5) by means of which they are attached to the rotor shaft (not shown). In this context, it is in particular also possible to provide that the three wings 104a-c are attached to the rotor shaft by means of a common lever arm and are arranged in a common securing device. At least the two rear wings 104b, 104c in the direction of flow are each embodied so as to be rotatable about a rotational axis 106b, 106c here.

In the basic position illustrated on the right in FIG. 5, the three wings 104a-104c are in contact and are positioned or angled with respect to one another in such a way that an overall curvature of the buoyancy device is produced. In this context, it is alternatively also possible to provide a gap between the three wings 104a-c. Said gap is adapted to a first total flow (cf. FIG. 2). If the wavelength and therefore the orbital flow and/or the relative flow and therefore the total flow changes, this curvature can be reduced by reducing the respective angles of attack of the wings 104a, 104b and/or 104c. For this purpose, at least one of the wings 104a, 104b and 104c is rotated about its respective rotational axes 106a, 106b and 106c. As a result, the curvature of the buoyancy device is adapted to a total flow with reduced curvature.

FIG. 6 shows a further three-part buoyancy device according to a third exemplary embodiment of the wave energy machine according to the invention. The buoyancy device has three wings 204a, 204b, 204c which are arranged in parallel with one another and which are in principle of comparable shape and extend in parallel with one another and perpendicularly with respect to the plane of the drawing. The three wings 204a-c each have at least one lever arm (not shown in FIG. 6) by means of which they are attached to the rotor shaft (not shown). In this context, it is also possible to provide, in particular, that the three wings 104a-c are attached to the rotor shaft by means of a common lever arm and are arranged in a common securing device. At least the two wings 204b, 204c which are at the rear in the direction of flow are each embodied so as to be rotatable about a rotational axis 206b, 206c here.

The three wings 204a-c are in contact in the basic position illustrated on the left in FIG. 6 and are positioned or angled with respect to one another in such a way that an overall curvature of the buoyancy device is produced. In this context, alternatively it is also possible to provide a gap between the three wings. Said gap is adapted to a first total flow (cf. FIG. 2). If the wavelength and therefore the orbital flow and/or the relative flow and therefore the total flow changes, in the third exemplary embodiment of the wave energy machine according to the invention as in FIG. 6 this curvature can be increased by increasing at least one of the respective angles of attack of the wings 204a, 204b and 204c. For this purpose, the wings 204a, 204b and 204c are rotated about their respective rotational axes 206a, 206b and/or 206c. As a result, the curvature of the buoyancy device can be adapted to a total flow with increased curvature.

In order to adjust the respective three wings, 104a-c and 204a-c in FIGS. 5 and 6 it is additionally possible to provide a kinematic mechanism which adjusts the respective three wings jointly.

FIG. 7 shows two operating states of a rotor according to a fourth exemplary embodiment of the wave energy machine according to the invention in a lateral illustration. The rotor has a rotor shaft 302 to which a curved surface element 304 is coupled by means of at least one lever arm, just one lever arm 308 of which is illustrated in each case in FIG. 7. The curvature of the surface element 304 is adapted according to the invention to the curvature of the total flow 10, 12 (cf. FIGS. 1 and 2), but it can also be, in particular, an average operating state. In this context, the surface element 304 is coupled to the lever arms 308 in such a way that it can be displaced along a curved path (illustrated by dots). As a result, an angle of attack of the surface element 304 with respect to the total flow is set. On the left in FIG. 7 a comparatively small angle of attack is set. For this purpose, the surface element 304 is displaced comparatively far forward in the direction of rotation of the rotor. On the right in FIG. 7, the angle of attack of the surface element 304 is increased in comparison with the latter. For this purpose, the surface element 304 is displaced comparatively far in the rearward direction counter to the direction of rotation. Given such an adjustment of the wing there is advantageously low adjustment work compared to rotating the wing about a center of rotation since the flow resistance is significantly smaller in the inventive case illustrated.

FIG. 8 shows a wing-like buoyancy device according to a fifth exemplary embodiment of the wave energy machine according to the invention in a perspective view. The buoyancy device has five segments 404a-404e, the cross sections of which are wing profiles. The curvature or bulge of the segments 404a-404e is adapted according to the invention to the curvature of the total flow (cf. FIGS. 1 and 2). This may be, in particular, an average operating state. In this context, an angle of attack of the various segments 404a-404e can be set differently. This takes place via a rotary movement of the affected segment 404a-404e about a preferably common rotational axis 406, which runs parallel to the rotor shaft (not shown) and therefore essentially transversely with respect to the incoming flow direction of the wave. In this context, the different segments 404a-404e can be adapted to possible nonuniformities of the total flow. Furthermore, by means of the different segments 404a-404e it is possible, for example, to compensate a transitionally nonoptimum orientation of the rotational axis 406 or of the rotor shaft (not shown) with respect to the direction of the incoming flow of the waves and/or to achieve a rotation of the overall system with respect to orientation or the direction of the incoming flow.

FIG. 9 shows a wing of a sixth exemplary embodiment of the wave energy machine according to the invention in a perspective view. This has a main section 504, the curvature or bulge of which is adapted according to the invention to the curvature of the total flow (cf. FIGS. 1 and 2)—this may be, in particular, an average operating state. Two flap segments 511a, 511b are inserted into the main section 504, at the rear region thereof, and coupled to the main section 504 in an articulated fashion. With these flap segments 511a, 511b it is possible to change the angle of attack and/or the bend of the wing shown. With the flap segments 511a, 511b it is possible to adapt these parameters according to the invention to different total flows (cf. FIGS. 1 and 2). The division of the flap into two separate flap segments 511a, 511b permits flexibility during the setting of the angle of attack and/or the bending of the wing over the width of the incoming wave or orbital flow 3 (cf. FIGS. 1 and 2). In this context it is alternatively also possible to use more than two flaps.

The diameter of the orbital paths decreases as the water depth increases. Down from a water depth of half the wavelength, there is virtually no longer any orbital flow. All the buoyancy devices or all rotors of the wave energy machine according to the invention for absorbing the energy of the orbital flow 3 should therefore be arranged underneath and comparatively close to the surface of the water (not shown).

In addition to the fifth exemplary embodiment according to FIG. 8, the buoyancy device can be enclosed by a film in order to level out the steps between its segments 404a-e.

In addition to the sixth exemplary embodiment according to FIG. 9, the buoyancy device can be enclosed with a film in order to level out the steps between its flaps 511a, 511b with respect to the main section 504.

A rotating wave energy machine which serves for using a circulating orbital flow of an undulating body of water via at least one, possibly synchronously rotating, rotor, is disclosed. An output power is tapped at a rotor shaft and is converted upstream (in the power flux) by means of at least one buoyancy device of the rotor.

A cross section of the buoyancy device has at least one curvature or a bend which is embodied as a function of a curvature of a total flow. This means that the at least one bend or curvature is adapted with respect to a cross section which is optimized for a linear incoming flow, according to the prior art. During the configuration of the at least one bend or the curvature, the influence of the relative flow on the total flow is also taken into account, said relative flow being produced by the (desired) rotation of the rotor in the water (nonmoving in this consideration). During the operation of the rotating wave energy machine, this relative flow is superimposed on the circulating orbital flow which acts on the buoyancy device from the outside. As a result, a resulting total flow is produced which is curved about the rotor shaft, in every instantaneous recording.

### LIST OF REFERENCE NUMBERS

1 Wing
1′ Conformal transformation
2 Rotor shaft
3 Orbital flow
4 Wing
6 Lever arm
8 Lever arm
10 Total flow
12 Total flow
14 Center
16 Center
18 Rear region
19 Median line
20 Rear region
104a,104b,104c Wing
106b,106c Rotational axis
119a,119b,119c Median line
204a,204b,204c Wing
206b,206c Rotational axis
219a,219b,219c Median line
302 Rotor shaft
308 Lever arm
304 Surface element
309 Adjustment path
404a,404b,404c,404d,404e Segment
406 Rotational axis
504 Main section
511a, 511b Flap segment

1. A wave energy machine for using a circulating orbital flow of an undulating body of water, comprising:
at least one rotor having a rotor shaft, the rotor shaft being configured to enable an output power to be tapped therefrom; and
at least one buoyancy device of the rotor, the buoyancy device being configured to convert the output power,
wherein a cross section of the buoyancy device has one or more of at least one curvature and and at least one bend configured as a function of a curvature of a total flow, and
wherein the total flow is formed from superimposition of the orbital flow and of a relative flow of the rotor.

2. The wave energy machine as claimed in claim 1, wherein the one or more of the curvature and the bend are formed in accordance with a conformal transformation rule.

3. The wave energy machine as claimed in claim 2, wherein the transformation rule is w=e^{z}, and wherein the transformation rule for machines with a large radial extent takes into account one or more of lateral effects and depth effects of the orbital flow and, as a result of which, the total flow is not configured in a purely circular form.

4. (canceled)

5. The wave energy machine as claimed in claim 1, wherein the one or more of the curvature and the bend are set for an average operating state.

6. The wave energy machine as claimed in claim 1, wherein the one or more of the curvature and the bend are configured to be set actively or changed passively.

7. The wave energy machine as claimed in claim 1, wherein the curvature is configured to be set actively or changed passively continuously over the cross section of the buoyancy device.

8. The wave energy machine as claimed in claim 2, wherein the buoyancy device has at least one wing, and wherein the changes in depth of the at least one wing are disregarded by the conformal transformation rule.

9. The wave energy machine as claimed in claim 1, wherein the bend is configured to be set actively or changed passively by a flap coupled to a main section of the buoyancy device, or wherein the one or more of the curvature and the bend are formed in accordance with a conformal transformation rule, the buoyancy device has at least one wing, the changes in depth of the at least one wing are disregarded by the conformal transformation rule, and the bend is configured to be set actively or changed passively by the flap coupled to the main section of the buoyancy device.

10. The wave energy machine as claimed in claim 9, wherein, in each case, a distance is provided between the main section and the flap and a further element, and wherein the buoyancy device is a curved planar element.

11. (canceled)

12. The wave energy machine as claimed in claim 1, wherein the buoyancy device has a multiplicity of individual buoyancy elements configured to be rotated or pivoted separately from one another about their respective longitudinal axis and, as a result of which, the bend is configured to be set actively or changed passively.

13. The wave energy machine as claimed in claim 12, wherein a depth of the individual buoyancy elements or a distance between the individual buoyancy elements is selected in such a way that they form, in a basic position, an arc in cross section, and wherein buoyancy elements are configured to be rotated or pivoted into an opened position, as a result of which, the bend is one or more of reduced with respect to the basic position and enlarged with respect to the basic position.

14. (canceled)

15. The wave energy machine as claimed in claim 13, wherein the individual buoyancy elements are configured to be adjusted jointly by a kinematic device.

16. The wave energy machine as claimed in claim 1, wherein an angle of attack of the buoyancy device is configured to be set actively or changed passively.

17. The wave energy machine as claimed in claim 1, wherein different angles of attack are configured to be set actively or changed passively along the buoyancy device.

18. The wave energy machine as claimed in claim 17, wherein the buoyancy device has a multiplicity of segments, the different angles of attack of which along the buoyancy device are configured to be set actively or changed passively.

19. The wave energy machine as claimed in claim 17, wherein the different angles of attack are configured to be set actively or changed passively by one or more of a plurality of flap segments coupled to a main section of the buoyancy device and a twistable flap coupled to the main section of the buoyancy device.

20. The wave energy machine as claimed in claim 1, wherein the buoyancy device has an elastic outer skin.

21. (canceled)

22. The wave energy machine as claimed in claim 1, wherein the buoyancy device is attached to the rotor shaft by a lever arm, and wherein the buoyancy device is configured to be moved, with respect to an outer end section of the lever arm, along a curved adjustment path.

23. (canceled)

24. The wave energy machine as claimed in claim 1, wherein a trimming rudder is arranged on the buoyancy device, and wherein the trimming rudder is coupled to a flap or to a main section of the buoyancy device or to a rear edge or to a front edge of a wing or of a bent planar element.

25. (canceled)

26. The wave energy machine as claimed in claim 1, wherein one or more of (i) a braking torque is configured to be applied to the rotor and (ii) one or more of the angle of attack and the cross section of the buoyancy device are configured to be set in order to control a phase angle between the orbital flow and the rotor.
